(19) United States
(12) Patent Application Publication
(10) Pub. No.: US 2015/0000426 A1
(43) Pub. Date: Jan. 1, 2015

(54) Sample Conditioning System for Low Pressure Gas

(71) Applicant: Mustang Sampling, LLC, Ravenswood, WV (US)

(72) Inventors: Claude A. Rolston, St. Marys, WV (US); Kenneth O. Thompson, Ravenswood, WV (US)

(73) Assignee: Mustang Sampling, LLC, Ravenswood, WV (US)

(21) Appl. No.: 14/308,453

(22) Filed: Jun. 18, 2014

Related U.S. Application Data
(60) Provisional application No. 61/839,603, filed on Jun. 26, 2013.

(51) Int. Cl. G01N 30/30; G01N 30/32

(52) U.S. Cl. CPC G01N 30/30; G01N 30/32; G01N 2030/326; G01N 2030/025
USPC 73/863.11

(57) ABSTRACT

A system and method for conditioning of very low pressure gas samples extracted from a source, heating the samples, boosting the pressure to a level appropriate for analysis, regulating the gas sample temperature and pressure to prevent dew-point dropout from Joules Thompson condensation, and passing the gas sample to an a remotely located analyzer or analyzer array where the electrical power for the pressurizing pump and heated regulator is provided by heat tracing.

### PRIORITY CLAIM

This application claims priority of U.S. provisional application Ser. No. 61/839,603 filed Jun. 26, 2013.

### FIELD OF INVENTION

This invention relates to conditioning very low pressure gas samples and more, particularly, to conditioning of gas samples from hydrocarbon gas sources such as coal seams, landfills, and boil-off gas from LNG facilities and effluents from industrial processing such as power generation, manufacturing, and chemical processing for regulatory compliance. The purpose of this assembly is to raise the pressure of a very low pressure gas to a pressure and a temperature suitable for an analyzer such as a gas chromatograph without risk of gas component dew point dropout while allowing for remote placement of the analyzer from the gas take-off probe and conditioner assembly.

### BACKGROUND

Sample conditioning in the gas transmission field is well known. For example LNG transfer facilities typically employ sample takeoff equipment to allow for assessment of the latent energy content of the gas. However, in some cases, such as extraction from a biogas generating landfill or boil-off gas source, the sampled gas is at a pressure inadequate for passing to a conventional analyzer such as a gas chromatograph. In such cases, the pressure of the extracted sample must be boosted. Likewise, in the case of effluent monitoring using sophisticated and sensitive equipment and techniques for qualitative and quantitative analysis of effluent components, i.e., Secondary Ion Mass Spectrometry (SIMS), require a sample to be at a pressure useable by the analyzer. Such analysis is implicated for regulatory compliance, in a wide range of environmental and industrial monitoring, e.g., steam generation in power plants, gas purification, semiconductor fabrication, and paper production and facilities such as large scale cooling towers to monitor emissions/flue gas containing, for example, greenhouse gases, nitrogen oxides (NOₓ), sulfur oxides (SOₓ), volatile organic compounds (VOC), airborne particles, and aerosols.

In many cases where a gaseous sample is extracted from a source, it is impractical to position the associated analyzer in a protected environment such as a control room in close proximity to the take-off and preserve the physical nature of the native sample prior to analysis. During the course of communicating the sample to the analyzer the reduction in temperature and/or pressure can induce component separation, dew point drop-out from Joules-Thompson condensation, leading to inaccurate measurement. To overcome such problems, accommodations have been made to locate the analyzer and sensors proximate to the take-off, i.e., on a smoke stack, or include a complex pumping system proximate to the analyzer to draw the gas sample to it in a manner to prevent interim changes to the gas sample during transfer.

The problem of preserving the character of, for example, an LNG sample extracted from a high pressure pipeline remotely from an associated analyzer has been addressed by Applicant in, for example, its patent U.S. Pat. No. 8,056,399. However, such a system does not address the particular problems associated with low pressure sample extraction.

What is needed is a takeoff system that avoids the need for a pump to be associated in close proximity to the analyzer and/or placement of the analyzer in close proximity to the gas takeoff probe. In the field of flue gas monitoring of smoke stacks and the like, the analyzing equipment cannot be housed in a control room or occupied room which would be at a significant distance from the take-off probe; a distance amounting to hundreds of feet (tens or even a hundred or more meters).

### SUMMARY OF INVENTION

It is an object of the present invention to overcome the problems in the art and provide a low pressure gas conditioning system for remote placement from an associated analyzer.

It is another object of the present invention to provide a novel gas conditioning system that delivers a heated and pressurized gas sample to a remotely located analytical device utilizing existing power supplied by heat trace sample tubing.

Another object of the present invention is to provide gas sample conditioning from a very low pressure source where the gas pressure and temperature are regulated so as to be transmitted to remotely spaced gas analyzer or analyzer array.

These and other objects are satisfied by a system for conditioning gas samples from a low pressure gas source, comprising: a cabinet with an enclosed interior, a sample gas input line at least partially disposed in the cabinet interior; a heated gas regulator and for thermally conditioning a sample gas at a low pressure to a temperature preventing dew point condensation; a control unit for the heated regulator; a metering pump for drawing the low pressure gas sample into the cabinet and boosting the low pressure sample gas to a pressure of between 10-45 psig, said pump including an electric motor which projects from the exterior of the cabinet; a first heated sample gas line for communicating the heated gas sample from the heated regulator to the pump and a second gas line for communicating the heated and pressurized gas from the pump to a gas analyzer remotely spaced from the cabinet through an insulated conduit; electric power providing heat tracing extending through the insulated conduit and into the cabinet; and a shielded electrical junction box with a heat tracing input fitting and shielded electrical conduits extending between said junction box to each of the heated gas regulator, the control unit, and the electric motor of the pump.

Still other objects are satisfied by a method for conditioning a gas sample for analysis by a remotely space analyzer without loss of the native gas properties, comprising the steps of: extracting a gas sample from a low pressure source; communicating the extracted sample into a conditioning cabinet; heating the extracted gas sample in a heated regulator; pressurizing the gas sample to a select pressure with a non-contaminating metering pump; passing the pressurized and heated gas sample through a cabinet outlet by a conduit to a remotely spaced analyzer while maintaining thermal and pressure stability; and powering the heated regulator and metering pump with heat tracing passing into the conditioning cabinet through the conduit.

The invention herein is particularly suited for applications such as analysis of landfill gas, coal seam gas, boil off gas from a Liquefied Natural Gas processing facility, flue gas conditioning for analysis of effluent and pollutants for regulatory compliance, chemical process exhaust gases, etc. The invention generally possesses utility in any environment that involves conditioning and analysis of very low pressure gas samples by boosting the gas pressure to useable threshold, regulating the gas sample temperature to prevent dew-point dropout from Joules Thompson condensation, and passing the gas to an appropriate analyzer or analyzer array.

The invention can be associated with a cold temperature inlet gas such as that generated as boil off gas from an LNG facility. Following pipeline collection, the gas (which in this case is relatively clean and not requiring pre-filtration, is passed directly to the heated regulator before going to the pump to boost the pressure. In the case of LNG, the present invention maintains gas at least 30° F. above the expected hydrocarbon dew point. The resulting heated gas output temperature is controlled by an electronic temperature controller with PID algorithms and fed to the pressure augmenting pump and then exported through heat traced tubing to the analyzer location. Because the invention herein draws its electrical requirements from the electric heat tracing, it also dispenses with the need for extra power feeds for the pressure pump. This feature eliminates the need for additional wiring, junction boxes and the like resulting in additional installation and assembly cost savings.

By incorporating heat trace power and a metering pump with the takeoff probe and sample conditioning system, the invention allows for remote placement from an analyzer, e.g., gas chromatograph. In short, the gas sample is heated inside of the house regulator unit and pressurized to a useful level while preventing liquid condensation caused by the Joule-Thomson effect during the pressurization and sample transmission to a remotely located analyzer.

For the purpose of this description low pressure gas pressure is defined as being between negative and 0 psig to 10 psig. Commonly, a gas sample from a pipeline source is extracted from a collecting pipe by an insertion probe such as the Applicant's Certiprobe® (See FIG. 1). The collecting pipe is associated with a natural gas or hydrocarbon gas source, such as of landfill gas, coal seam gas, and boil off gas from a Liquefied Natural Gas processing facility, or from a smokestack or gas vent in a processing facility where the gases are typically at very low pressures. Such low pressures, e.g., <10 psi are too low for introduction into conventional gas chromatography equipment for analysis. Conventional analyzing equipment commonly require gas inlet input at higher pressures, i.e., between 10 psig and 25 psig for proper operation. Additionally, by boosting the pressure, the invention compensates for inherent pressure drop resulting from elongated sample lines, such as those from a stack.

In the following description, reference is made to the accompanying drawing, and which is shown by way of illustration to the specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### BRIEF DESCRIPTION OF THE DRAWINGS

FIG. 1 is a schematic diagram of a low pressure gas sample conditioning system in accordance with an embodiment of the invention.

FIG. 2 is a schematic diagram of a low pressure gas sample conditioning system in accordance with another embodiment of the invention.

### DETAILED DESCRIPTION

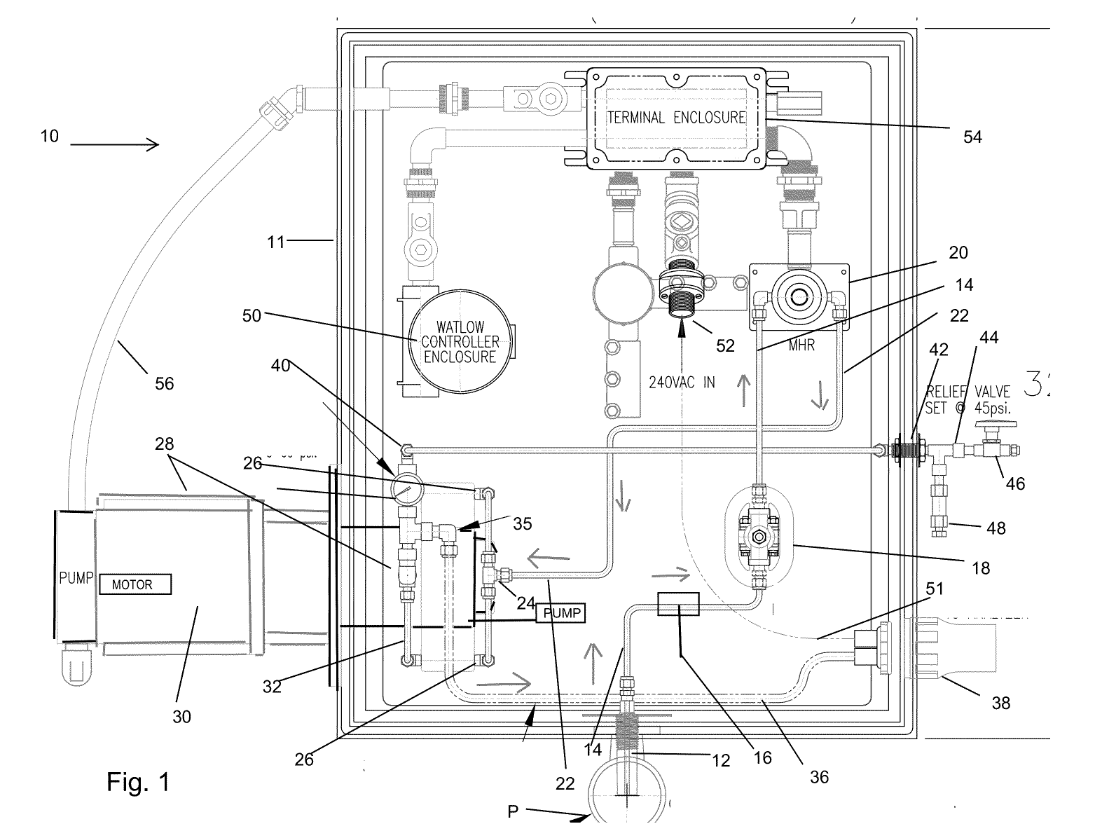

FIG. 1 is an embodiment 10 of a low pressure sample conditioning system according to the invention. Sample conditioner 10 is specifically adapted for sample extraction, processing and conditioning a source gas at a very low positive or even a negative pressure. This embodiment contemplates a weatherproof cabinet 11 having a direct connection between a pipeline takeoff probe 12 for communication of the gas sample extracted by a probe from the collection pipe source P to the conditioner 10. That gas, if obtained from a “dirty” source such as a smokestack, exhaust vent, landfill, etc., may be passed through a particulate filter 16 disposed in stainless steel sample input tube 14 for communicating the extracted sample to a heated regulator 20.

The heated regulator 20 thermally conditions the extracted sample by heating it to a temperature that allows processing that minimizes dew point dropout. Flow of the gas sample to the regulator 20 is controlled by an inlet isolation valve 18 (which, in the case of LNG or other cryogenic fluid may be a cryogenic valve). Following thermal conditioning (e.g., ˜100° F.), the vaporized gas sample is drawn from the heated regulator 20 via stainless steel output tube 22. The output tube 22 leads to a tee-connector 24 for splitting the sample gas stream and for input into pump inputs 26. The low pressure gas sample is pressure conditioned by metering pump 28 which pulls the gas sample from the takeoff probe 12, drawing through the heated regulator 20 and pressuring the sample to 25-30 psi, a level compatible for input to a downstream analyzer.

The pump 28 may be a peristaltic or single diaphragm but preferably is of the type corresponding to the explosion proof double diaphragm pump adapted for hazardous atmosphere use. One such available pump is the Dia-Vac® Model series R201-FP-NA1from Air Dimensions, Inc. of Deerfield Beach, Fla. Because the pump 28 illustrated in FIG. 1 is a dual diaphragm pump it includes dual inputs 26 connected to the regulator output line 22 via the tee connector 24. Use of a diaphragm pump or a peristaltic pump is preferred because it avoids sample contamination as it has no oil, graphite or other contaminating lubricants that could come in contact with the gas sample stream. The use of a dual diaphragm arrangement also serves to minimize output pulsations to a downstream analyzer.

In the case of flammable gas such as LNG vapor, as illustrated in FIG. 1, the electric pump motor 30 preferably is isolated from cabinet interior and sample gas lines by being positioned externally of the cabinet while the pump itself is located within the cabinet interior.

The pressure and thermally conditioned gas samples are passed out of the pump 28 through pump outlet 32 (the upper outlet is hidden behind the pressure gauge 34) and connected to a output tee-connector 35. The recombined heated and pressurized gas sample pass passed to stainless steel tubing analyzer feed line 36 to the cabinet outlet feedthrough 38. A stainless steel grab sample/pressure relief line 40 is also provided which passes through feedthrough 42 to a further tee-connector 44 with output to a pressure relief valve 46, set to 45 psi to prevent over pressurizing the gas being fed to the analyzer, and a grab sample port 48 allowing for periodic and selective collection of archival samples. The streaming conditioned gas sample is fed via line 36 to an associated gas analyzer, e.g., gas chromatograph for standard evaluation.

The cabinet and regulator temperatures are monitored by a controller 50 such as that available from Watlow. Such a controller with the appropriate microprocessing capacity can also be used in connection with a more automated system such as one relying on remote takeoff, permitting system start-up and shut down, solenoid valve control, and gas flow monitoring.

Turning now to the electrical power feeds for the various system components, the invention contemplates use of heat tracing where the heat trace connection originate in the downstream analyzer (not illustrated), passing the entire length of gas sample tubing 36 extending between feedthrough 38 and the analyzer, and into the cabinet interior via the feedthrough 38. From there, the heat tracing 51 passes through heat trace input fitting 52 to enclosed and shielded AC connector junction box 54 which is rated for 230 volts. The junction box 54 is electrically connected to the pump motor 30 via shield connector 56 which passes from the cabinet interior to exterior through an appropriate feedthrough. Shielded tubing is also used to connect to the other electrically powered components within the cabinet interior, i.e., the heated regulator 20 and controller 50. Heat trace power provision of this type is described in Applicant's patents U.S. Pat. No. 7,162,933 and 8,056,399, the subject matter of both being incorporated by reference in their entirety.

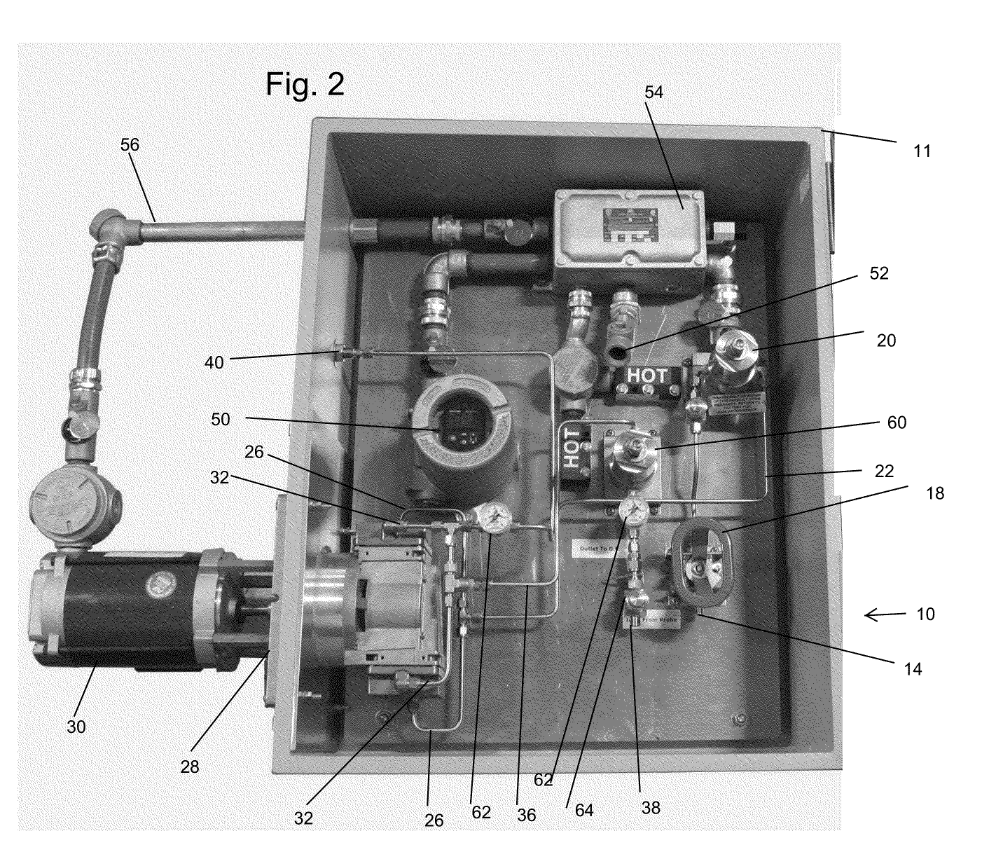

The embodiment depicted in FIG. 2 largely corresponds to that described in connection with FIG. 1 but includes a second heating regulator 60 to insure thermal stability and prevent dew point drop out of the gas sample following pressurization to 30 psi prior to output to the downstream analyzer. It also includes liquid filled gauges 62 on the relief and output lines for monitoring the gas sample pressure and an isolation valve 64 to terminate gas flow to the analyzer. In the case of use on a smokestack or the like where cryogenic gases are not involved, a simple isolation valve may be substituted for the cryogenic isolation valve 18 at the sample inlet.

Embodiments of the invention have now been disclosed. However, it should be understood by those skilled in the art that many modifications and embodiments of the invention will come to mind to which the invention pertains, having benefit of the teaching presented in the foregoing description and associated drawing. It is therefore understood that the invention is not limited to the specific embodiment disclosed herein, and that many modifications and other embodiments of the invention are intended to be included within the scope of the invention. Moreover, although specific terms are employed herein, they are used only in generic and descriptive sense, and not for the purposes of limiting the description invention.

What is claimed is:

1. A system for conditioning a gas sample from a low pressure gas source, comprising:
a cabinet with an enclosed interior,
a sample gas input line at least partially disposed in the cabinet interior;
a heated gas regulator and for thermally conditioning a sample gas at a low pressure to a temperature preventing dew point condensation;
a control unit for the heated regulator;
a metering pump for drawing the low pressure gas sample into the cabinet and boosting the low pressure sample gas to a pressure of between 10-45 psig, said pump including an electric motor which projects from the exterior of the cabinet;
a first heated gas sample line for communicating the heated gas sample from the heated regulator to the pump and a second gas line for communicating the heated and pressurized gas from the pump to a gas analyzer remotely spaced from the cabinet through an insulated conduit;
electric power providing heat tracing extending through the insulated conduit and into the cabinet; and
a shielded electrical junction box with a heat tracing input fitting and shielded electrical conduits extending between said junction box to each of the heated gas regulator, the control unit, and the electric motor of the pump.

2. The system according to claim 1 further including a pressure relief line and valve located external of the cabinet for relieving pressure exceeding 45 psi of the gas sample following pressurization by the pump.

3. The system according to claim 2 where the pump is a peristaltic pump.

4. The system according to claim 3 where the pump is a dual diaphragm pump.

5. The system according to claim 4 further including a tee-connector in the first heated sample gas line for splitting the gas sample into first and second equal streams for input into the pump.

6. The system according to claim 5 where the pump includes a first and a second gas sample outputs further including a tee-connector in the second gas line combining the outputted heated and pressurized gas sample.

7. The system according to claim 6 further including a second heated regulator disposed in said second gas

8. The system according to claim 7 further including an isolation valve in said input line.

9. The system according to claim 8 where said isolation valve is a cryogenic valve.

10. The system according to claim 9 further including an in-line particulate filter positioned in the cabinet interior and upstream of the isolation valve in said input line.

11. The system according to claim 10 further including a grab sample connection associated with the pressure relief line and proximate to the relief valve.

12. The system according to claim 11 further including an isolation valve disposed in the cabinet interior and in said second gas line.

13. The method of conditioning a low pressure gas for communication to a remotely located analyzer using the system of claim 1.

14. A method for conditioning a gas sample for analysis by a remotely space analyzer without loss of the native gas properties, comprising the steps of:
extracting a gas sample from a low pressure source;
communicating the extracted sample into a conditioning cabinet;
heating the extracted gas sample in a heated regulator;
pressurizing the gas sample to a select pressure with a non-contaminating metering pump;
passing the pressurized and heated gas sample through a cabinet outlet by a conduit to a remotely spaced analyzer while maintaining thermal and pressure stability; and
powering the heated regulator and metering pump with heat tracing passing into the conditioning cabinet through the conduit.

15. The method of claim 14 where the conditioning cabinet includes a gas sample relief line extending from the pump to the cabinet exterior further comprising the step of relieving gas pressure in excess of 45 psi.

16. The method of claim 15 where the metering pump is a dual diaphragm pump further comprising the step of splitting the heated extracted gas sample for pressurization.

17. The method of claim 16 where the conditioning cabinet includes a second heated regulator comprising the step of heating the gas sample after pressurization.
